(19) United States
(12) Patent Application Publication
(10) Pub. No.: US 2019/0381902 A1
(43) Pub. Date: Dec. 19, 2019

(54) ROAD CHARGING FOR ELECTRIC VEHICLE IN MOTION

(71) Applicant: Antenum LLC, Merrimack, NH (US)

(72) Inventors: John T. Apostolos, Lyndeborough, NH (US); William Mouyos, Windham, NH (US); James D. Logan, Candia, NH (US)

(21) Appl. No.: 16/358,770

(22) Filed: Mar. 20, 2019

Related U.S. Application Data
(60) Provisional application No. 62/645,750, filed on Mar. 20, 2018.

(51) Int. Cl. B60L 53/12; H02J 7/02; H02J 50/40; H02J 50/23; H02J 50/27

(52) U.S. Cl. CPC B60L 53/12; H02J 7/025; H02J 50/27; H02J 50/23; H02J 50/40

(57) ABSTRACT

A loop antenna in an electric vehicle receives energy wirelessly from a source external to the vehicle, such as from a series of Radio Frequency (RF) emitters embedded in a road surface. The use of single turn, RF loop antennas to both transmit and receive power greatly reduces the need to align the vehicle with the charging equipment.

### CROSS REFERENCE TO RELATED APPLICATIONS

This application claims the benefit of a co-pending U.S. Provision Application No. 62/645,750 filed Mar. 20, 2018 entitled “ROAD CHARGING FOR ELECTRIC VEHICLE IN MOTION”, and is related to a co-pending U.S. patent application Ser. No. 15/861,749 filed Jan. 4, 2018 entitled “LOW PROFILE ANTENNA—CONFORMAL the entire contents of each of which are hereby incorporated by reference.

### BACKGROUND

### Technical Field

This patent application relates to charging an electric vehicle while in motion over a road surface.

### Background Art

A worldwide revolution in transportion is well underway at this time. Motivated by the reduction and re-location of air pollution generators, the next decade is expected to see the demise of the internal combustion engine as the dominant power plant for transportation on land. Electric cars create no emissions, and the power plants required to generate their energy and pollution can be located wherever is required to totally eliminate smog and pollution in large urban areas.

Electric cars can be conveniently charged at fixed service stations or at business or a home location.

It has been suggested for some time that electric vehicles can also be powered while in motion. For example, U.S. Pat. No. 4,139,071 describes an arrangement where a roadway having a smooth road surface for automotive vehicles includes means for transmitting electric current through the road. Each electrified traffic lane is provided with at least two spaced parallel electrical contact assemblies mounted with their top surfaces flush with the road surface and in position to be contacted one with a wheel on each side of the vehicle.

As described in U.S. Pat. No. 5,573,090 electric vehicle charging may also occur through a network of power coupling elements, e.g., magnetic coils, embedded in a roadway. Inductive coupling is used to transfer power from the embedded roadway coupling coils to the vehicle, with the preferred coupling frequency in the 1-10 KHz range. U.S. Patent Publication US2012/0217111A1 entitled “Roadway Powered Electric Vehicle” also describes a vehicle that obtains charge via inductive power transmission modules (wire coils) embedded in the road.

U.S. Pat. No. 9,561,730 describes a stationary “conductive charging interface” that receives a first AC power signal from an AC power distribution network via an antenna circuit configured to wirelessly receive charging power at a level sufficient to power or charge an electronic device or vehicle. Capacitvely loaded multi-turn coils form a resonant structure that couples energy from a primary structure (transmitter) to a secondary structure (receiver) via the magnetic near field if both primary and secondary are tuned to a common resonance frequency. The method is also known as “magnetic coupled resonance” and “resonant induction.” Some exemplary embodiments may use a frequency in the range from 20-60 kHz.

And U.S. Pat. No. 9,126,490 describes an arrangement for charging a stationary vehicle where a first coil is configured to wirelessly receive power to power or charge an electric vehicle; a second passive circuit includes a second coil configured to wirelessly receive power from a transmit circuit comprising a third coil, and configured to wirelessly retransmit power. A controller that detects misalignment between the third coil and the first coil, and displace the second coil from the first in response.

### SUMMARY

While it is well known to embed inductive wire coils along a road surface, prior systems and methods do not (a) use a series of single turn wire loop antennas embedded in a road to transmit energy to a vehicle at radio frequencies; (b) use a parasitically fed wire loop in the vehicle that is larger than the wire loops in the road; or (c) use the same single turn two loop antennas for transmitting communication signals to the vehicle.

In the embodiments described herein, a single turn, wire loop antenna in an electric vehicle receives energy wirelessly from one or more Radio Frequency (RF) emitters embedded in a road surface. The RF emitters transmit energy also using a single turn, wire loop antenna that is somewhat smaller in diameter than the loop antenna in the vehicle. The use of RF loop antennas to both transmit and receive power greatly reduces the need to precisely align the vehicle antenna with the charging antenna. The arrangement thus has distinct advantages over known inductive charging systems that use inductive coils.

The transmitted signal may be modulated to enable communications.

Low profile conformal directional antennas may also be embedded in the road surface to support higher data rate communications, direction finding and other functions.

### BRIEF DESCRIPTION OF THE DRAWINGS

FIG. 1 is block diagram of a vehicle charging arrangement according to one or more embodiments herein;

FIG. 2 shows a series of single turn wire loops embedded in the travel lanes of a roadway;

FIG. 3 is a more detailed circuit diagram of the charging arrangement;

FIG. 4 is another embodiment where directional antennas and/or data modulation/demodulation, Time of Flight (TOF), or Receive Signal Strength Indication (RSSI) circuits are also used in the vehicle and/or in-ground components;

FIG. 5 is another configuration where a directional antenna structure is placed in the in-ground cavity with the single turn wire loop;

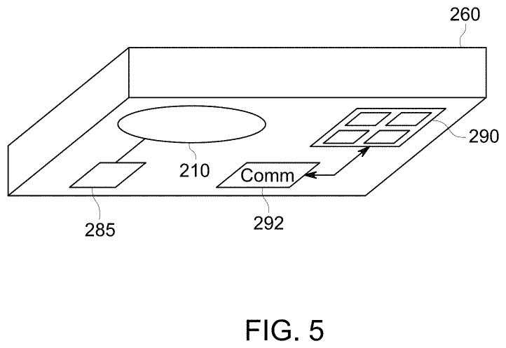

FIG. 6 is a model used in simulating the system;

FIG. 7 is a circuit digram used in simulating the system;

FIG. 8 is a simulation output showing efficiency versus operating frequency;

FIG. 9 is a simulation output showing coupling efficiency versus loop separation;

FIG. 10 is a simulation output showing coupling efficiency versus loop height;

FIG. 11 is a simulation output showing coupling efficiency versus frequency and its dependency on loop offset; and

FIG. 12 is a simulation output comparing asphalt versus earth performance.

### DETAILED DESCRIPTION OF AN EMBODIMENT

We have developed a system and method of wireless energy transmission which optimizes the efficiency and flexibility required for general applications to the problem of charging vehicles in motion where there are few other alternatives. What sets our design apart from traditional transformer coupled systems is a unique electromagnetic coupling circuit operating both in magnetic and electric coupling modes at radio frequencies, such as those in the High Frequency (HF) and Very High Frequency (VHF) band. This permits implementing a wide variety of interface circuitry around the coupler to account for changes in the environment and positioning of the vehicle with respect to the charging system. This interface circuitry can be electronically controlled, allowing real-time adaptation to dynamically changing environments such as would be encountered in a buried highway charging system. It also allows using low cost methods of high power signal processing such as class-E amplifiers and synchronous rectifiers.

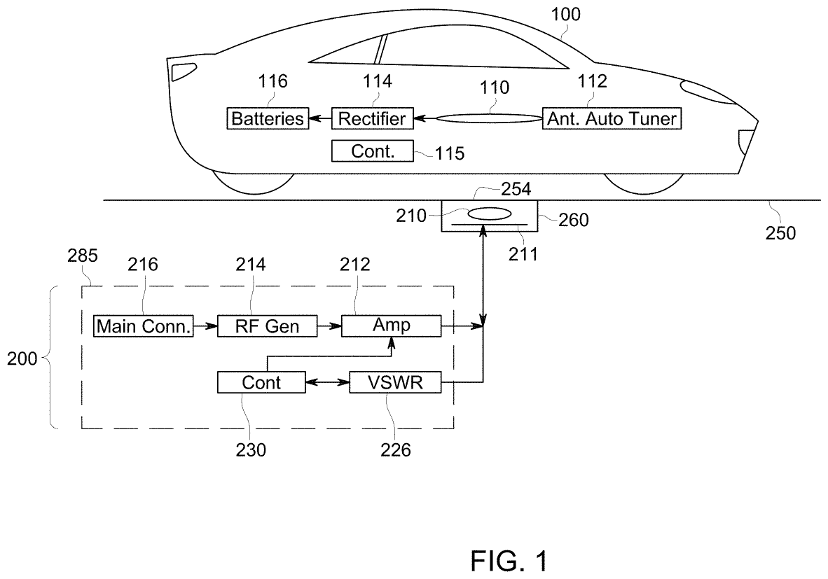

A functional block diagram is shown in FIG. 1. An electric vehicle 100 includes a generally circular, single turn, wire loop receive antenna 110, an automatic antenna tuner 112, a rectifier 114, a controller 115, and an energy storage device such as one or more batteries 116. An in-road charging station 200 includes another, smaller, single turn, wire loop transmit antenna 210 placed beneath the surface 250 of a road and typically within a cavity 260 over a ground plane 211. Only a single charging station is shown in FIG. 1 but it should be understood that a network of such stations are embedded along a road.

Each charging station 200 also includes charging circuitry 285 such as a Radio Frequency (RF) amplifier 212, an RF signal generator 214, a connection 216 to a power source such as a connection to main line Alternating Current (AC) connection. Also typically included is a controller 230, VSWR meter 226.

In one implementation, the vehicle loop antenna 110 may be a 0.25 inch metal pipe approximately 3 feet in diameter. The vehicle loop antenna 110 may be parasitically fed power from the charging antenna 210.

The charging loop antenna 210 may have a somewhat smaller diameter than the vehicle loop antenna 110, such as between 0.5 and 1 foot placed over a 30-inch square ground plane (screen) about four inches below the surface 250 of the road. In preferred embodiments, the charging loop antenna is at least three times smaller in diameter than the vehicle antenna 210. Having the parasitically fed vehicle loop antenna 210 somewhat larger in diameter than the charging loop antenna 110 reduced the need for critical alignment between the charging station 200 and the vehicle 100. However, in other implementations the charging loop 210 and receive loop 110 may be more or less of the same diameter.

Although the loops are shown as generally circular in diameter, they may also be rectangular or square.

The charging antenna 210 may be actively fed from the amplifier 212 such as via a microstrip connection.

In one embodiment, energy is transferred from the charging loop antenna 210 to the vehicle loop antenna 110 at a radio frequency near 50 MHz; this may preferably be within one of the unlicensed radio bands in the 49 MHz range. However, operation at other radio frequencies is possible.

For RF transmission in or near 49 to 50 MHz, one expects a transmit antenna 210 with such small dimensions (between 0.5 and 1 foot) to be a relatively inefficient radiator; therefore its signal strength in the far field (more than a couple of feet away) would be significantly reduced. However, one potential advantage of this arrangement is that a floor or other components of the vehicle 100 above the vehicle loop antenna 110, if formed of primarily metal or other conductive surfaces, will naturally act as a radio frequency shield. The vehicle 100 itself can thus also serve to attenuate the radio frequency energy emitting from charging antenna 210 from leaking into the surrounding area.

The metallic floor of the vehicle, closely spaced to the receiving loop 110 also acts a ground plane and thus as an RF mirror to reflect energy in the 49 to 50 MHz frequency range. This mirror image acts to further increase efficiency.

The arrangement in FIG. 1 is in general similar to that described in more detail in U.S. patent application Ser. No. 15/887,066 filed Feb. 2, 2018 entitled “ELECTRIC VEHICLE CHARGING VIA RF LOOPS TO AVOID NEED FOR PRECISE ALIGNMENT WITH A WIRELESS CHARGING EQUIPMENT” hereby incorporated by reference.

In many implementations, it is desirable to reduce the amount of power reflected back into the transmitter amplifier 212, in other words, to minimize the Voltage Standing Wave Ratio (VSWR). However the VSWR will be different for different positions of the charging loop 210 and vehicle loop 110 with respect to one another. Thus a VSWR meter 226 may be placed on the transmit side to detect RF energy reflected back from the charging loop 210. The VSWR meter 226 output feeds a controller 230 that then controls some attribute of the amplifier 212, such as its output impedance. Any known analog or digital control techniques may be utilized for this feedback control of the transmit VSWR. Automatic tuner 112 on the vehicle side may use any known analog or digital techniques for controlling an adjustable impedance disposed in or adjacent to vehicle loop antenna 110. The automatic antenna tuner 112 further permits the position of the charging station loop antenna 210 to be somewhat independent of the exact position of the vehicle 100. The automatic receive tuner 112 thus eliminates what might otherwise be a cumbersome, difficult to achieve, highly accurate positioning required of charging systems that use multiple turn inductive coils. Such inductive coils used in prior systems must be congruently aligned with one another to operate properly.

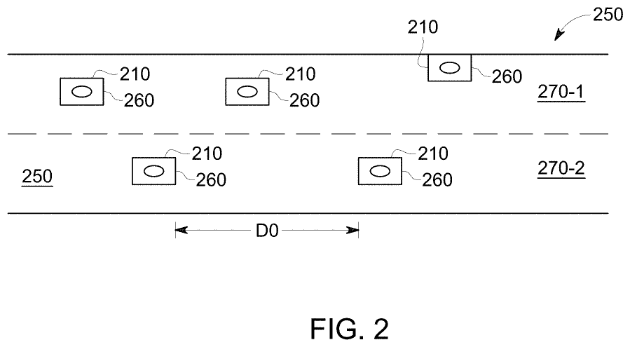

The system is particularly adapted so that vehicle 100 can be charged as it drives along a road that has a series of charging (transmit) loop antennas 210 embedded within it. In this arrangement, shown in FIG. 2, transmit loops 210 are embedded within and along the travel lanes 270-1, 270-2 of a roadway. Each loop 210 is disposed in a shallow cavity 260 along with the charging electronics 285 as already mentioned above. Distance Dₒ between stations is not considered to be critical for the system to work, but some design considerations include how much power the vehicles 100 each consume, the traffic volume and speed, general expected operating conditions (such as how wet, humid or dry the climate is), whether continuous charging is important, and other factors. As explained in more detail below, simulation results show that efficiencies of 80% and higher are possible.

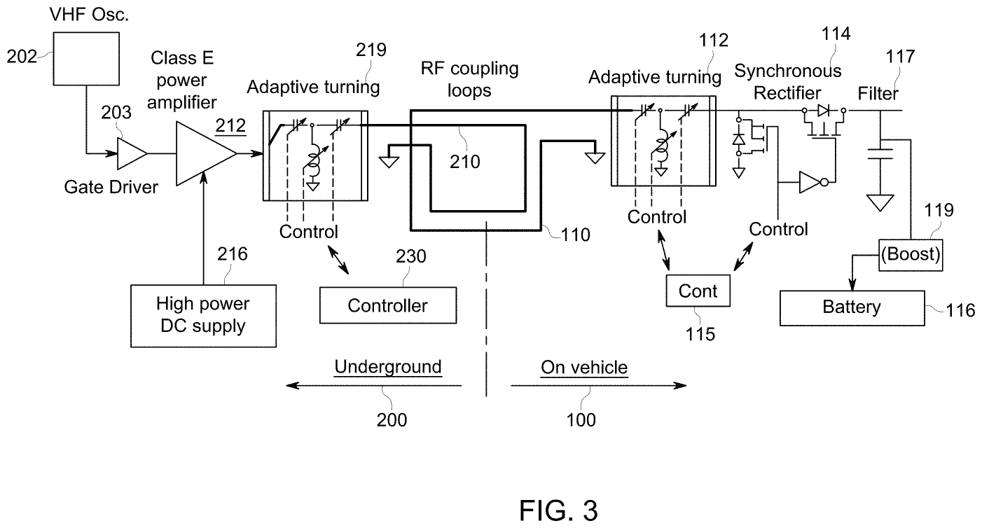

FIG. 3 is a more detailed circuit diagram of the system components. On the transmit side, the charging station 200 consists of a VHF oscillator 202, feeding a gate driver 203 for the power amplifier 212, which may be a class E power amplifier fed from a DC supply 216 such as may be powered by a main line AC power source. Adaptive tuning circuits 219 may be controlled by the controller 230. Adaptive tuning 291 may include one or more circuits with adjustable inductance and capacitances. In turn the tuning circuit 219 feeds the transmit loop antenna 210.

On the vehicle (receive) side, the receive loop antenna 110 feeds adaptive tuning circuits 112 which may in turn be controlled by a controller 115. Synchronous rectifier 114 also controlled by controller feeds a low pass filter 117 to charge the battery 116 through an optional boost circuit if desired.

In practice, the networks around the loops can be electronically controlled using mechanical servomotors, switches and/or varactor diodes. These are computer driven (e.g., by the controllers 115, 230) in real time.

This implementation thus supports several additional functions as follows. Adaptive tuning 219 and/or 112 can compensate for misalignment of the electric vehicle charging coils to 210, 110; or can allow for dynamic changes in operation in response to differences in road-to-vehicle geometry as the batteries are being charged; or may compensate for differences in materials within the electric vehicle and/or different vehicle battery types; and/or improve efficiencies of the power amplifier under changing conditions of load, frequency, drive level and transmitted waveform.

The use of a synchronous rectifier 114, synchronized to the transmit waveform frequency, can further optimize efficiency of the charging system.

Also, the optional boost converter 119 can provide greater isolation of the charging system.

### Other Embodiments

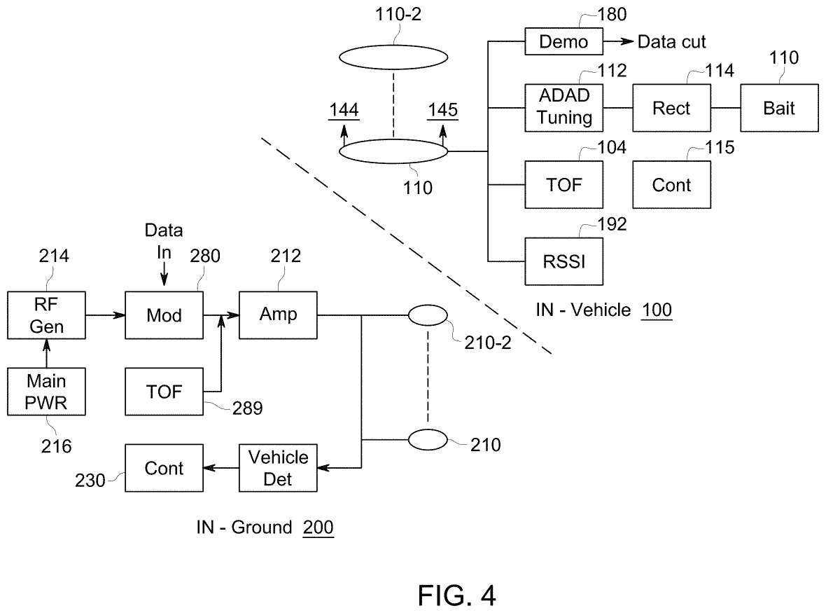

With reference to FIG. 4, in some environments, there may be enough room under the vehicle for a second receive loop 110-2 in juxtaposition to the original loop 110 along a direction of travel. This geometry would thus allow for charging over a longer distance, such as say 6 feet. More of these receive loops in series would thus permit charging perhaps over the entire length of the vehicle.

If a sufficient number of transmit antennas 210, 210-2 are placed along the road and closely spaced with respect to one another (such as every 6 feet), the vehicle may even be charged over its entire distance of travel.

However in a situation where the charging loops 210, 210-2 are spaced apart from one another, a vehicle detection sensor may be coupled to the transmit loop 210, detect a change in the impedance of the input of the transmit loop 210 or 210-2, feed that signal to the controller 230 which then initiates the charging mode by switching on the amplifier 212.

The same deployment of antennas in the vehicle and along the road can also be used for electric vehicle charging as well as micro-location and communications. Such an arrangement would permit a system might offer three functions as a package: EV charging, data communications, and precise positional information.

Data Communications

Data can be communicated to the vehicle using the loop antennas 110, 210 by digitally modulating 280 the charging signal and by having a corresponding demodulator 180 on the receive side in the vehicle.

In another arrangement, data might be transmitted at higher and different frequencies and data rates, such as at WiFi frequencies by also embedding other antennas in the road. For example, a directional antenna 290 and associated radio communication circuits 292 (cell phone or WiFi) may be disposed in the cavity 260 alongside the loop 210 and charging electronics 285.

Directional antenna 290 may be of the flat, conformal type of antennas described in U.S. patent application Ser. No. 15/861,749 filed Jan. 4, 2018 entitled “LOW PROFILE ANTENNA—CONFORMAL”. To implement that features, such low profile directional conformal antennas may be embedded in the road as the antennas for a series of WiFi each routers. If needed, these conformal antennas could be structurally reinforced to support the weight of vehicles driving over them. The arrangement should be an improvement over deploying a series of antennas along the side of the road and above ground.

In addition, the low profile conformal antennas are directional, permitting the data signals to be steered in the direction of the vehicles' travel, up and down the road.

Positioning

The same road infrastructure may also be used to precisely locate cars in real time. The electric vehicles can act as cooperating “tags” that receive and process directional beacon signals. Time of flight (TOF) detection circuits as shown in FIG. 4 may be added to the receive circuitry (TOF 191) in the vehicles and to the electronics (TOF 289) in the road, in order to resolve distances from each other.

And with a multiplicity of such measurements, it would also be possible to triangulate using multiple TOF measurements in order to obtain vehicle location.

In addition, location information might be resolved via “stereoscopic vision” from multiple direction finding antennas embedded in the road, with or without TOF measurements. That approach may be preferred if there were low profile conformal antennas in both lanes of travel in order to give provide some width between the “eyes”.

If data is also being transmitted on the pair of loops, or if something similar is needed just for positioning, the vehicle may alternatively have two antennas 110, 110-2 underneath it. These two antennae could then be coupled to triangulation circuitry using Receive Signal Strength Indication (RSSI) 192 or TOF 194 to determine the location of the car relative to the next upcoming loop 110 (and perhaps the last one just passed by, too.)

In another approach, it may be possible to triangulate using the energy being refracted off the corners of the vehicle. In that scenario, the transmit loop could have a modulator 280 that generates some sort of permutation that would generate a certain deterministic signal. That signal might then be compared to the strength of the rest of the signal by demodulator 180 thus giving a sense of where the car was relative to the unsymmetrical form of the pattern coming off the transmit loop 210.

Vehicle Charging while in Motion

Furthermore, it is possible to tap Radio Frequency Energy off the vehicle loop antenna on each side of it, such as at taps 144, 145, and compare the two detected signals, and thereby figure out how well centered the receiving loop was relative to the transmit loop and adjust the adaptive tuning 112 as a result. That one dimension correction (perpendicular to the direction of travel) may be helpful in terms of keeping the car electronically “lined up” as it travels over the charging loops.

Simulation Results

In a perfect scenario, the loops 110, 210 would always be positioned centered over each other as the vehicle 100 travels along the road 250 and remain at a fixed known height, such that dissipation power losses are minimized and efficiency is maximized. However that cannot be achieved in practice since there is no control over exactly where the vehicle is positioned laterally with the road, and due to the fact that different vehicles have different ground clearance.

To obtain some appreciation for the effect of variation in alignment, height and operating frequency an HFSS simulation was performed, with a design goal of maximizing the efficiency, |s₂₁²|/(1−|s₁₁|²). This function of s-parameters is the ratio of the output power to the power accepted by the network and is sensitive to power lost by heating of the network.

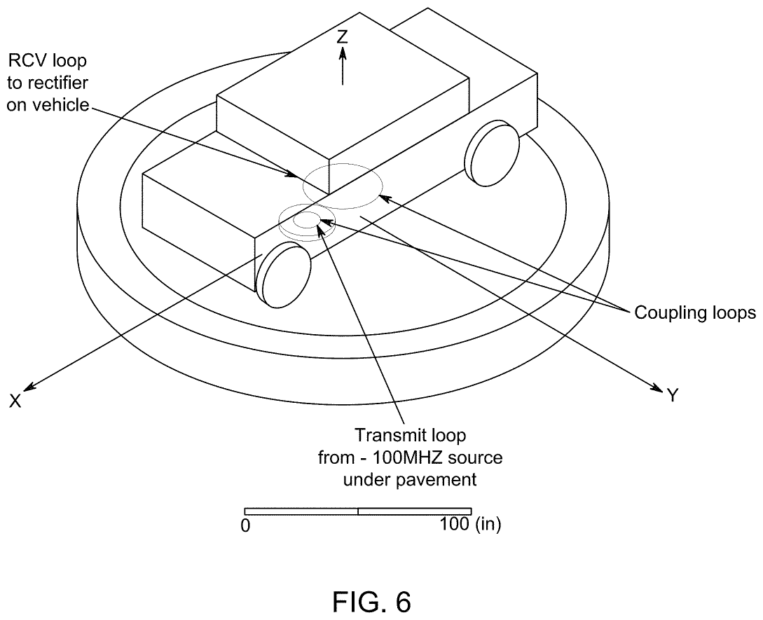

FIG. 6 shows the three dimensional model of the car and antennas used in simulating the system.

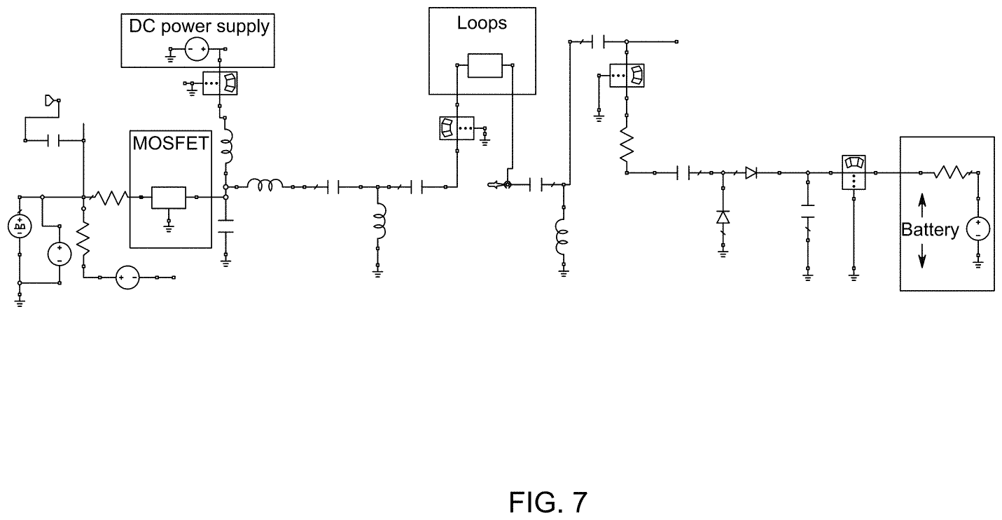

FIG. 7 is a circuit digram used to simulate the electronics on the transmit and receive sides. The simulation used a subcircuit of measured wired loops embedded into a larger circuit including inductors and capacitors. The loop subcircuit was modelled from measured data. The simulation is nonlinear, including diode rectifiers for AC to DC conversion; the values of the inductors and capacitors were optimized to maximize the energy transfer from source to load.

Simulation results show a possible overall efficiency greater than 90%. This includes loss from the DC power source into the class E amplifier to the DC power delivered to the load representing the battery. Depending on what battery voltage is charged, multiple power amplifiers and rectifiers can be combined to accommodate any reasonable power level up the kilowatt range. Proper positioning of the loops insures minimal radiation and environmental impact. According to simulations, burying the transmit loop in asphalt is possible with a small effect on efficiency.

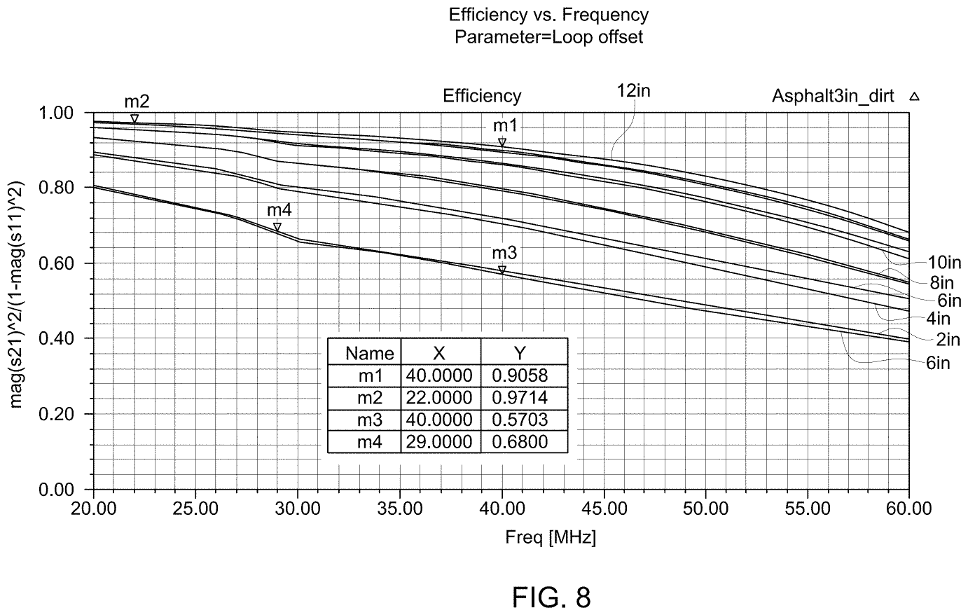

FIG. 8 is a simulation output showing efficiency versus operating frequency

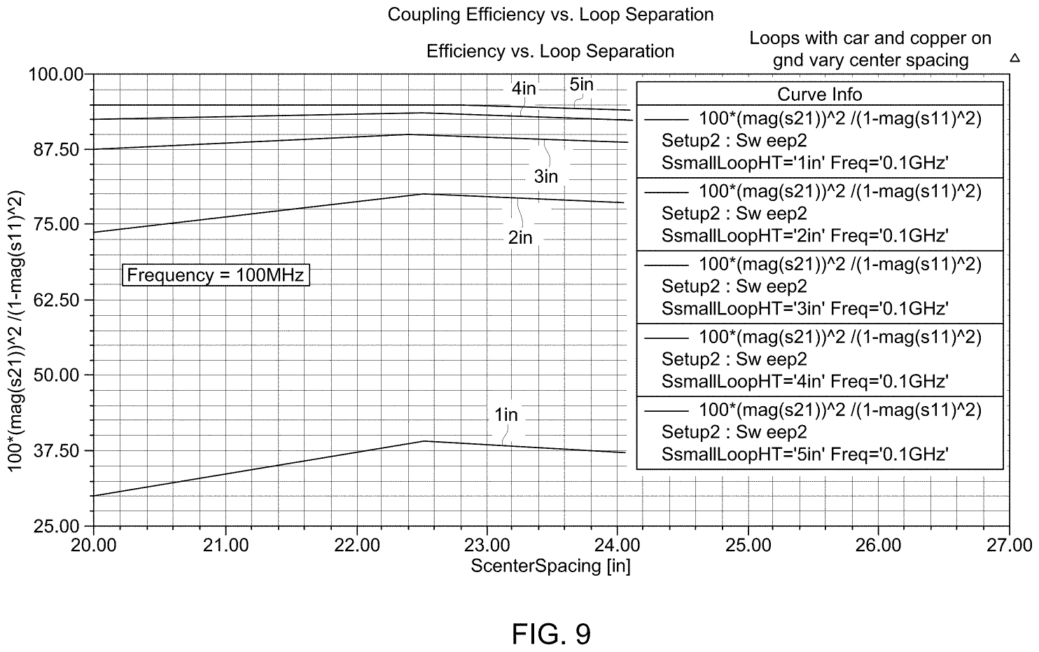

FIG. 9 is a simulation output showing coupling efficiency versus loop separation—in other words, RF transfer efficiency as a function of the separation between the centers of the transmit and receive loops as the vehicle moves over the transmit loop.

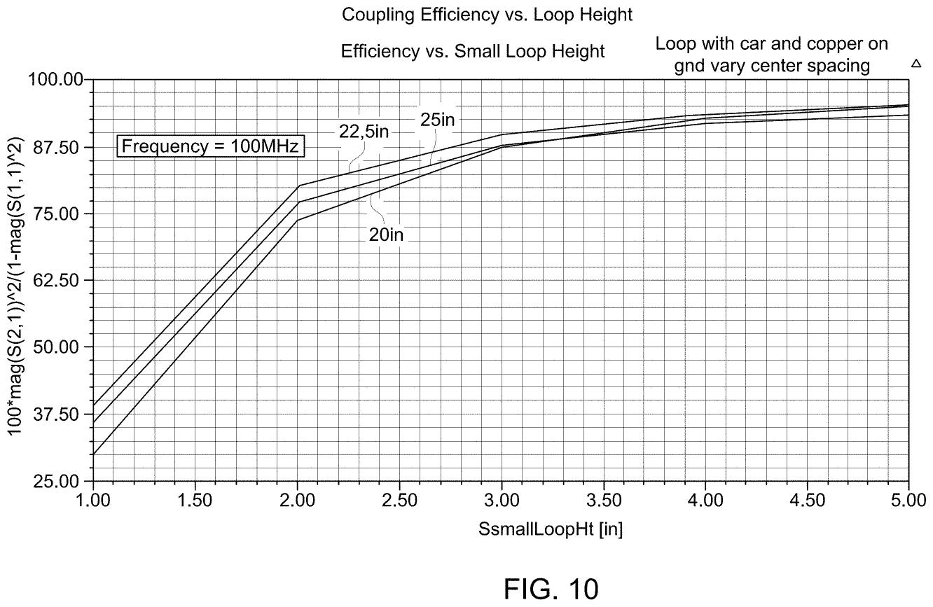

FIG. 10 is a simulation output showing coupling efficiency versus loop height in inches.

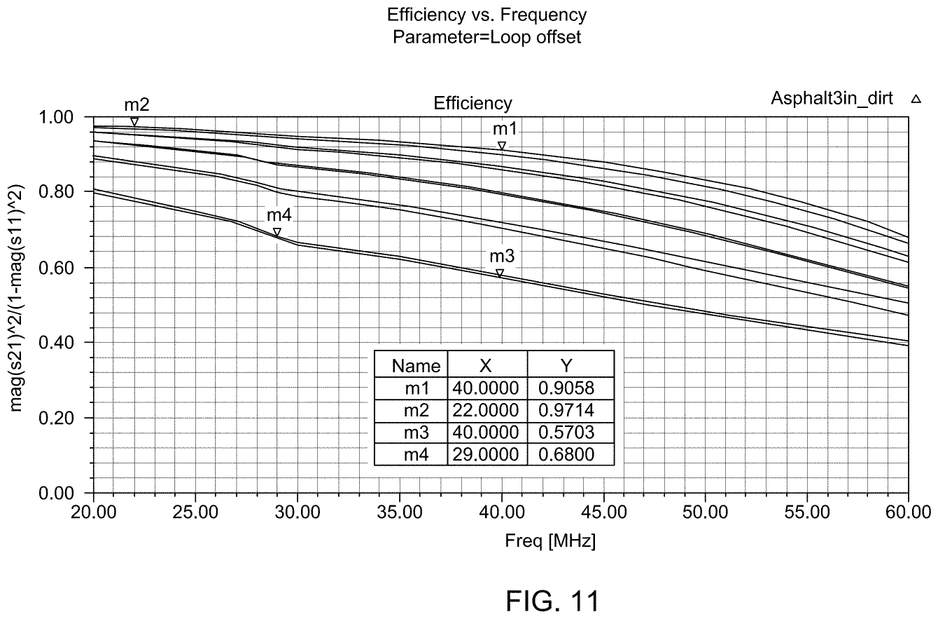

FIG. 11 is a simulation output showing coupling efficiency versus frequency and its dependency on loop offset.

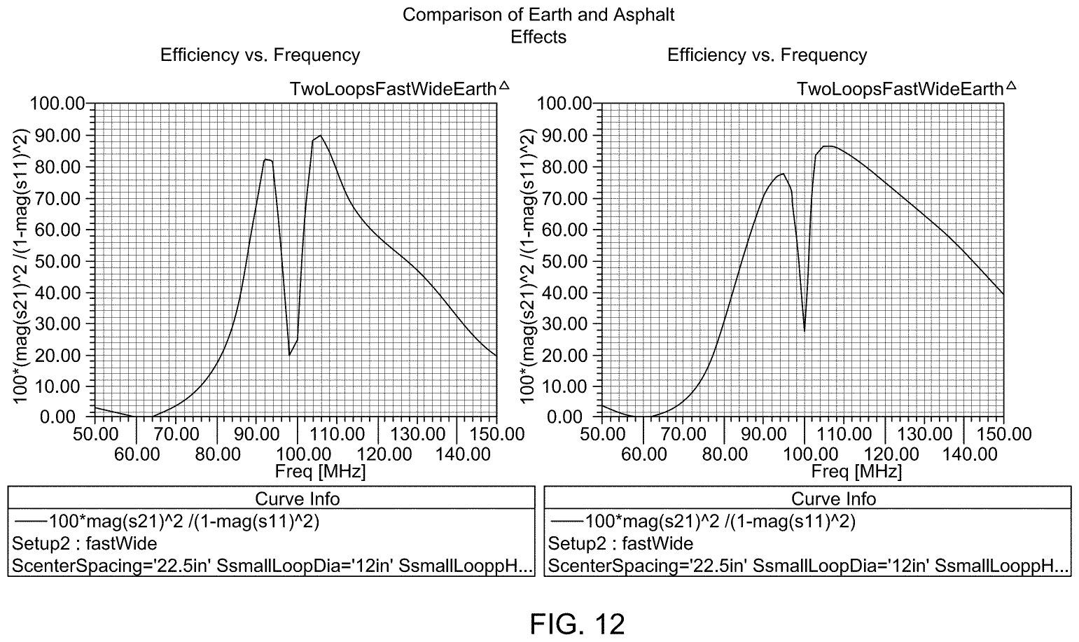

FIG. 12 is a simulation output comparing performance over an asphalt road versus a dirt road (pure earth).

### Other Design Considerations

Simulations indicated that total efficiency is limited by the parameters of available inexpensive MOSFET transmit amplifiers. Lowering the operating frequency to 27 MHz (in the ISM band) opened up other options for selecting the amplifier. In one embodiment, the oscillator was a VHF oscillator having a frequency stability of 0.1%, the gate driver was specified to drive 200 pF at 27 MHz, the power amplifier was a Mitsubishi RD16HHS MOSFET having Pdiss<57 watts, the matching impedances were air core inductors and mica capacitors (BV<100v) and the rectifier was a voltage doubler circuit using 1N4003 diodes.

The foregoing description of example embodiments illustrates and describes systems and methods for implementing a vehicle charging system, but is not intended to be exhaustive or to limited to the precise form disclosed.

For example, certain portions may be implemented as electronics or block diagram components that performs one or more functions. These components may include hardware, such as hardwired logic, an application-specific integrated circuit, a field programmable gate array, or may also include in whole or in part, a processor that executes software instructions. Some or all of the logic may therefore be stored in one or more tangible non-transitory computer-readable storage media and may include computer-executable instructions that may be executed by a computer, a data processing system, application specific integrated circuit, programmable gate array or any other state machine. The computer-executable instructions may include instructions that implement one or more embodiments described herein.

It also should be understood that the block and process flow diagrams may include more or fewer elements, be arranged differently, or be represented differently. For example, while a series of steps has been described above with respect to the flow diagrams, the order of the steps may be modified to achieve the same result. In addition, the steps, operations, and steps may be performed by additional or other hardware or software modules or entities, which may be combined or separated to form other modules or entities. For example, while a series of steps has been described with regard to certain Figures, the order of the steps may be modified in other consistent implementations. Further, non-dependent steps may be performed in parallel. Further, disclosed implementations may not be limited to any specific combination of hardware or software.

It will thus now be apparent that other variations and modifications may be made to the described embodiments, with the attainment of some or all of their advantages. The above description of the embodiments, alternative embodiments, and specific examples, were thus given by way of illustration and should not be viewed as limiting. Therefore it is the object of the appended claims to cover all such variations and modifications as come within the true spirit and scope of the disclosure herein and their equivalents.

What is claimed is:

1. A method for charging an electric vehicle as it travels along a road surface comprising:
a single turn, receive loop antenna, disposed within the vehicle;
a series of single turn, transmit loop antennas, arranged beneath the road surface, and to coupled to an energy source to transmit energy via a radio signal; and
with a diameter of the receive loop antenna at least three times a diameter of the transmit loop antennas.

2. The method of claim 1 additionally comprising:
digitally modulating the radio signal.

3. The method of claim 1 additionally comprising:
determining a relative position of the vehicle from the radio signal.

4. The method of claim 1 additionally comprising:
detecting a position of the vehicle; and
selectively coupling the energy source to the transmit antenna depending uping the detected position.
